(19) United States
(12) Patent Application Publication
(10) Pub. No.: US 2010/0250431 A1
(43) Pub. Date: Sep. 30, 2010

(54) SYSTEMS, METHODS, AND MACHINE-READABLE MEDIUMS FOR PROVIDING REAL-TIME DATA OF COMMERCIAL AND FINANCIAL ACTIVITY OF A BUSINESS TO A FINANCIAL INSTITUTION TO GUIDE CREDIT OPERATIONS AND RISK MANAGEMENT

(76) Inventor: Edson Silva, Florianopolis (BR)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/500,116

(22) Filed: Jul. 9, 2009

Related U.S. Application Data
(60) Provisional application No. 61/164,854, filed on Mar. 30, 2009.

(51) Int. Cl. G06Q 40/00

(52) U.S. Cl. 705/38; 705/35

(57) ABSTRACT

Systems, methods and machine-readable mediums for providing real-time data of commercial and financial activity to a financial institution to guide credit operations and risk management. The system may include a processor configured to receive commercial and financial data for a plurality of businesses, transmit the data to a storage device for storage, determine if at least one business has a projected negative cash flow, generate a report to identify at least one business that has a projected negative cash flow, and transmit the report to at least one financial institution terminal to facilitate a financial institution's credit operations and risk management. The computer readable mediums provide instructions to cause the processor to perform the operations above. As such, the methods, systems and machine-readable mediums embodied in the present disclosure allow financial institutions to extend lines of credit with higher confidence and reduced risk.

### RELATED APPLICATION

This application claims the benefit of and priority to U.S. Provisional Application Ser. No. 61/164,854, filed Mar. 30, 2009, by Edson Silva, entitled SYSTEM, METHOD AND MACHINE-READABLE MEDIUM FOR PROVIDING VISIBILITY OF TRANSACTIONS IN A COMMERCIAL ECOSYSTEM, the contents of which are incorporated by reference herein in its entirety.

This application is also related to the following co-pending U.S. patent applications, filed concurrently herewith, by Edson Silva, and which are incorporated herein by reference in their entirety: (a) U.S. patent application Ser. No. ______ (Attorney docket No. 116454.200200), entitled SYSTEMS, METHODS AND MACHINE-READABLE MEDIUMS FOR MANAGING COMMITMENTS AND ACCOUNT RECEIVABLES; (ii) U.S. patent application Ser. No. ______ (Attorney docket No. 116454.200300), entitled SYSTEMS, METHODS AND MACHINE-READABLE MEDIUMS FOR SUBMITTING ELECTRONIC LOAN APPLICATIONS TO A LENDING INSTITUTION WITH REAL-TIME COMMERCIAL AND FINANCIAL DATA; and (iii) U.S. patent application Ser. No. ______ (Attorney docket No. 116454.200400), entitled SYSTEMS, METHODS AND MACHINE-READABLE MEDIUMS FOR CONSOLIDATING FINANCIAL INFORMATION FROM MULTIPLE ACCOUNTS MAINTAINED WITH A PLURALITY OF FINANCIAL INSTITUTIONS.

### BACKGROUND

Companies have recently been using more credit to finance their operations. Conventional operations of receiving an order, manufacturing a product, transporting the product, and only then, receiving money, is no longer the norm. The tendency is now to receive the order, get credit to finance the production, manufacture the product, transport the product and receive the payment to pay the credit. In some cases, the conventional relationship will be present from the seller view point, but the buyer will be financing the payment.

This disclosure relates generally to business management systems, methods and machine-readable mediums. More particularly, this disclosure relates to systems, methods and machine-readable mediums for providing real-time data of commercial and financial activity to a financial institution to guide credit operations and risk management.

### SUMMARY

Systems, methods and machine-readable mediums for providing real-time data of commercial and financial activity to a financial institution, to guide credit operations and risk management, are provided. The system may include a storage device and a processor. The processor may be configured to receive commercial and financial data for a plurality of businesses, transmit the data to the storage device for storage, determine if at least one business has a projected negative cash flow, generate a report to identify at least one business that has a projected negative cash flow, and transmit the report to at least one financial institution terminal to facilitate a financial institution's credit operations and risk management. The commercial information may include purchase orders, receipts, invoices, titles, and contracts. The financial information may include payments, collections, bank statements and credit card statements. In one embodiment, the processor may be further configured to generate a cash flow report to allow the financial institution to evaluate the financial condition of the at least one business within a certain period.

In one embodiment, the system may include a business management module adapted to facilitate commercial and financial transactions. The business management module may be adapted for real-time integration of the commercial information received from a plurality of business terminals. The business management module may be further adapted to extract financial information from the commercial information and determine if at least one business has a projected negative cash flow. The business management module may be adapted to generate a cash need report to identify at least one business that has a projected negative cash flow, and transmit the report to at least one financial institution terminal to facilitate a financial institution's credit operations and risk management. The business management module may also be adapted to generate a cash flow report, and to transmit the cash flow report to at least one financial institution terminal to evaluate the financial condition of the at least one business within a certain period.

The method for providing real-time data of commercial and financial activity of a business to a financial institution includes receiving real-time commercial and financial data for a plurality of businesses and storing the real-time commercial and financial data in a storage device. The method further includes determining, from the real-time commercial and financial data, if at least one business has a projected negative cash flow, generating a report to identify the at least one business that has the projected negative cash flow, and transmitting the report to at least one financial institution terminal to facilitate a financial institution's credit operations and risk management. In one embodiment, the method further includes generating a cash flow report of the at least one business within a certain period, and transmitting the cash flow report to at least one financial institution terminal for use in evaluating the monthly payment capacity of the at least one business.

The computer readable mediums provide instructions to cause the processor to perform the operations above. As such, the methods, systems and machine-readable mediums embodied in the present disclosure allow financial institutions to extend lines of credit with higher confidence and reduced risk, and allow businesses to receive credit with lower interest rate for maintaining competitiveness in the marketplace.

### DRAWINGS

The above-mentioned features and objects of the present disclosure will become more apparent with reference to the following description taken in conjunction with the accompanying drawings wherein like reference numerals denote like elements and in which:

FIG. 1 illustrates an exemplary block diagram of a system for providing real-time commercial and financial data, according to one embodiment of the present disclosure.

FIG. 2 illustrates an exchange of commercial and financial data through the visibility system of FIG. 1, according to an embodiment of the present disclosure.

FIG. 3 illustrates an exemplary flowchart outlining the operation of the visibility system of FIG. 1, according to an embodiment of the present disclosure.

FIG. 4 illustrates an exemplary flowchart outlining the operation of the visibility system of FIG. 1 for identifying, to a financial institution, potential companies qualified to receive credit, according to an embodiment of the present disclosure.

### DETAILED DESCRIPTION

In the description that follows, the present inventions will be described in reference to one or more embodiments that provide real-time data of commercial and financial activity of a business to a financial institution to guide credit operations and risk management. The present inventions, however, are not limited to any particular application nor is it limited by the examples described below. Various modifications to the disclosed embodiments will be apparent to those skilled in the art and the general principles defined herein may be applied to other embodiments and applications without departing from the spirit and scope of the inventions. Therefore, the description of the embodiments that follow are for purposes of illustration and not limitation.

Embodiments of the present disclosure include systems, methods and machine-readable mediums for providing real-time data of commercial and financial activity of a business to a financial institution for visibility to guide credit operations and risk management. The systems, methods and machine-readable mediums may be adapted to automatically identify potential companies to a financial institution for extending credit with low risk.

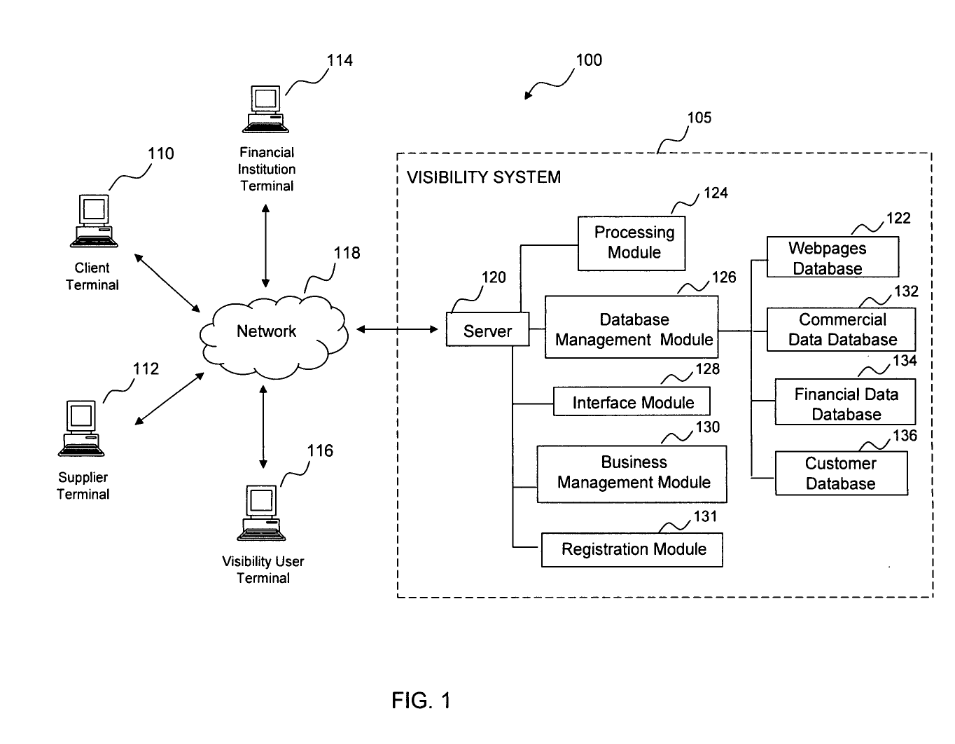

FIG. 1 illustrates an exemplary block diagram of a system 100 for providing real-time commercial and financial data, according to one embodiment of the present disclosure. The real-time commercial and financial data of a business may be provided to a financial institution for visibility to guide credit operations and risk management. As used herein, “real-time” may refer to a mode of computer operation by which a computer updates data at substantially the same rate as the data is being received by the computer. “Real-time data” may include substantially up-to date information available on a computer system.

As shown in FIG. 1, a visibility system 105 may be accessible to a client terminal 110, a supplier terminal 112, a financial institution terminal 114 and a visibility user terminal 116, such as personal computers, phones and personal digital assistants, via a network 118. The terminals 110, 112, 114, 116 may run commercially-available Web browser applications such as Microsoft Internet Explorer®, which implements World Wide Web standards such as HTTP, HTML, XML, java, Flex, Ajax and the like.

In one embodiment, the visibility system 105 may include a server 120, one or more modules and one or more storage devices. The website content may be distributed over several Internet domains, and may be implemented using several servers located at various locations. Of course, a variety of networks, both public and private, may be used as well. The visibility system 105 may use a commercially-available Internet server 120 which accesses a web page database 122 that may be used to store and/or dynamically generate Web pages in response to end user actions. The Web pages may be in the form of HTML pages or the like.

The server 120 may include one or more processors for implementing one or more functional modules, such as a processing module 124, a database management module 126, an interface module 128, and a business management module 130. As used herein, the term module refers to logic implemented in hardware and/or software. It may include a collection of software instructions, possibly having entry and exit points, written in a programming language, such as, for example, C++. A software module may be compiled and linked into an executable program, or installed in a dynamic link library, or may be written in an interpretive language such as BASIC. It will be appreciated that software modules may be callable from other modules, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays. The modules described herein are preferably implemented as software modules, but could be represented in hardware or firmware.

In one embodiment, each module is provided as a modular code object, where the code objects typically interact through a set of standardized function calls. In one embodiment, the code objects are written in a suitable software language such as C++, but the code objects can be written in any low level or high level language. In one embodiment, the code modules are implemented in C++ and compiled on a computer running a content server, such as, for example, Microsoft.RTM. IIS or Linux.RTM. Apache. Alternatively, the code modules can be compiled with their own front end on a kiosk, or can be compiled on a cluster of server machines and transmitted through a cable, packet, telephone, satellite, or other telecommunications network. Artisans of skill in the art will recognize that any number of implementations, including code implementations directly to hardware, are also possible.

The database management module 126 may be used to provide database management functions for interrelated storage devices, including, for example, a web pages database 122, a commercial data database 132, a financial data database 134, and a customer database 136. As is well known, database categories above can be combined, further divided or cross-correlated, and any combination of databases 122, 132, 134, 136 and the like can be provided from within the server 120. In one embodiment, any portion of the databases can be provided externally from the visibility system 105, either locally on the server 120, or remotely over a network. The external data from an external database can be provided in any standardized form which the server 120 can understand. For example, an external database at a provider can advantageously provide end-user data in response to requests from server 120 in a standard format, such as, for example, name, user identification, and computer identification number, and the like, and the end-user data blocks are transformed by the database management module 126 into a function call format which the code modules can understand. The database management module 126 may be a standard SQL server, where dynamic requests from the server 120 build forms from the various databases used by the visibility system 105 as well as store and retrieve related data on the various databases.

As can be appreciated, the databases may be used to store, arrange and retrieve data. The databases may be storage devices such as machine-readable mediums, which may be any mechanism that provides (i.e. stores and/or transmits) information in a form readable by a processor. For example, the machine-readable medium may be a read only memory (ROM), a random access memory (RAM), a cache, a hard disk drive, a floppy disk drive, a magnetic disk storage media, an optical storage media, a flash memory device or any other device capable of storing information. Additionally, machine-readable medium may also comprise computer storage media and communication media. Machine-readable medium includes volatile and non-volatile, removable and non-removable media implemented in any method or technology for storage of information such as computer-readable instructions, data structures, program modules or other data. Machine-readable medium also includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by a computer.

In one embodiment, the commercial data database 132 may be used to store commercial records for at least one client and/or supplier business. For example, the commercial data database 132 may store any electronic data associated with a commercial transaction, such as, but not limited to, purchase orders, receipts, invoices, titles, contracts, etc. The financial data database 134 may be used to store financial records for at least one client and/or supplier business. For example, the financial data database 134 may store payments, collections, bank and credit card statements, etc.

The customer database 136 may be used to store data associated with a customer account for a user to access the visibility system 105. For example, the customer database 136 may be used to store sign up information associated with the customer account. The customer may be a client accessing the client terminal 110, a client's supplier accessing the supplier terminal 112, a financial institution accessing the financial institution terminal 114, or any other user with preauthorized rights to access the client's records and accessing the visibility user terminal 116.

The processing module 124 may be responsive to the receipt of customer log-in information from the client terminal 110, the supplier terminal 112, the financial institution terminal 114 and/or the visibility user terminal 116. The processing module 124 may be used to retrieve a customer profile data from customer database 136 in response to the customer log-in information. The processing module 124 may be operatively associated with a number of different modules. For example, the processing module 124 may be operatively associated with the business management module 130 to process commercial and financial data transmitted to and from the visibility system 105. In one embodiment, the processing module 124 may be used to receive commercial and/or financial data from at least one client terminal 110, and transmit the commercial and/or financial data to a database for storage. For example, the commercial data may be transmitted to the commercial data database 132 and the financial data may be transmitted to the financial data database 134 for storage. In one embodiment, the processing module 124 may be used to consolidate the commercial and financial data, and provide a credit report for each of the at least one client business. The processing module 124 may also be used to transmit the report to at least one visibility user terminal 116, such as a financial institution terminal with preauthorized access rights, to facilitate the financial institution's credit operations and risk management.

The interface module 128 may be operatively associated with a number of different modules. For example, the interface module 128 may be operatively associated with the registration module 131 to register users to the visibility system 105. The interface module 128 may be implemented to receive an identifier, such as an account username and password, for logging onto the visibility system 105 and for accessing associated customer account. By logging onto the visibility system 105, customers may securely access published information from partners, clients or suppliers, contract service, request anticipation of receivables, offer credit, emit second copy of billets, access invoices published by its partners, track scheduled payments, make reductions in financial documents based in the receivables, track orders/requests, digitize receipts, among other services.

In one embodiment, the interface module 128 may be used to send and receive documents in diverse formats and protocols, and convert messages/documents in one or more pre-determined formats for each customer (client/supplier/financial institution). The documents may be transmitted to the visibility system 105 from the customer, or transmitted to the customer from databases 122, 132, 134 of the visibility system 105.

The registration module 131 may be used to facilitate registration with the visibility system 105. The registration module 131 may be responsive to a customer's request to register on the visibility system 105. The registration module 131 may be responsive to customer information received in response to the prompting of customer information for storage in customer database 136. The customer information may be used to set up a customer account with the visibility system 105.

The business management module 130 may be used to provide business management functions for commercial and financial transactions. For example, the business management module 130 may be used to consolidate financial and commercial information for providing new and strategic data to approve credit lines and limit credit risks. The business management module 130 may be used to convert and/or integrate all documents from commercial transactions and extract the financial information therefrom. For example, orders generated at the client terminal 110 may be converted into future payments, and orders received at the client terminal 110 may be converted into receivables. Additionally, invoices received at the client terminal 110 may be combined with the orders and future payments, redefining the details of these payments. Similarly, invoices generated at the client terminal 110 may be combined with the receivables, redefining details of these receivables. All other documents may be integrated as well, allowing the client and/or visibility user, through their respective terminals 110, 116, to access and view all the selling and buying process from a financial viewpoint.

In one embodiment, the business management module 130 may be used to facilitate financial transactions between, for example, a client terminal 110 and a supplier terminal 112. For example, the business management module 130 may be used to schedule and transmit payment conciliation to the financial institution terminal 114. As can be appreciated, the business management module 130 may be used to provide a history log of all documents exchanged between a client and each of its business partners, suppliers, etc., and the related cash flow. In one embodiment, the business management module 130 provides such information to the client terminal 110 upon log-in to the visibility server 105. In another embodiment, the business management module 130 provides such information to any visibility user terminal 116, such as a terminal at a financial institution, with preauthorized access rights from the client business. By having access to the client business' documents (future payments and receivables), the financial institution has visibility to the business' commercial and financial condition, and as such, can provide credit with a lower risk.

In one embodiment, the business management module 130 may be a set of integrated systems providing one or more functional applications to support the automation, standardization, publication, control and management of integrated public and private companies in their value chain. For example, the business management module 130 may be used to integrate customers, such as, but not limited to, clients, suppliers, banks, credit card companies, transport companies, insurance companies, governments and others business partners. The business management module 130 may be configured for multiple interfaces, for financial, logistic, and mercantile portals, for registration and electronic contracting, and for multiple individual configurations of available portals. In one embodiment, the business management module 130 may be used to automate and modernize the traditional process of orders, receipts, payments, collections, bank statements, scan of client, electronic contracts, including other logistic, mercantile and financial procedures, rules and forms.

As can be appreciated, the business management module 130 may be configured to provide different functionalities and access rights for different customers. For example, the business management module 130 may provide different information related to the profile of each customer (client, supplier and/or financial institution) accessing the visibility system 105. In one embodiment, the business management module 130 may be used to facilitate the connectivity and transport of data in a secure environment. The business management module 130 may be used for mapping and translation of electronic document layouts, and optionally supplying standard layouts to customers. For example, it permits each customer to utilize a certain electronic document layout or adopts an industry standard layout, making the electronic exchange of information among customers (clients/suppliers/financial institutions) feasible. Hence, the business management module 130 may facilitate remitting and/or receiving information, such as mercantile-logistics and/or financial information, without the need of altering the format of any existing document.

In one embodiment, the business management module 130 may be used to integrate business partners (clients, suppliers, transport companies, insurance companies, etc) by facilitating the electronic exchange of orders to suppliers, receipts/invoices to clients, knowledge of boarding, confirmation of receipts, including other logistic and/or mercantile documents. The business management module 130 may also be used to integrate client terminal 110 or supplier terminal 112 with financial institution terminal 114 for electronic exchange of financial information, for example, payments, collections, bank and credit card statements, electronic scan of billets, purchases, sells, among others financial documents. The business management module 130 may be used to electronically manage collections for a supplier company and its clients to enable, for example, the remittance of billets by email, publication on the client's profile webpage, or remittance of electronic files to clients. Furthermore, it may be used to notify the supplier terminal 112 when a client terminal 110 accesses the visibility system 105 for tracking billets from remittance to payment.

As can be appreciated, the business management module 130 may facilitate electronic scans to track collections registered with the financial institution terminal 114 and/or the visibility system 105. Additionally, the business management module 130 may be used to manage payments from clients to suppliers, for example, by authorizing payments to suppliers, payment of tributes with or without bar code, authorizing payroll, and publication of payments and commitments recognized for the suppliers. Payments are identified as payables to the client and receivables to the supplier. The business management module 130 may be operatively associated with the database management module 126 to transmit financial information, such as payables and receivables, to the financial data database 134 for storage.

In one embodiment, the business management module 130 may be used to generate financial documents in connection with commitments and receivables. For example, the business management module 130 may allow a supplier at a supplier terminal 112 to generate financial documents (collection, payments) from documents of commitments published (receipt, invoices and titles). Furthermore, the business management module 130 may be used to manage the assembly of commitments, the anticipation or payment by installments of commitments, and the generation of a new billet with reduced value based on previous billets and receivables. When the client company renders a payment, the business management module 130 may be used to reconcile the commitments with the payments scheduled/rendered. The business management module 130 may also be used to manage the anticipation of receivables. The business management module 130 may be used to post commitments recognized by the client company to the supplier, and may request the anticipation of receivables based on such information.

In one embodiment, the business management module 130 may also be used to capture, consolidate and publish on one or more web pages, any bank statements from a plurality of bank accounts maintained at a plurality of financial institutions.

As is understood by a person skilled in the art, the code modules may be compiled on one or more servers 120, each having one or more processors, to perform a set of functional calls. In one embodiment, the one or more processors may be configured, programmed and/or provided code instructions from one or more modules to receive commercial and/or financial data from at least one client business terminal, and transmit the commercial and/or financial data to a database for storage. For example, the commercial data may be transmitted to the commercial data database 132 and the financial data may be transmitted to the financial data database 134 for storage. In one embodiment, the processor may be configured, programmed and/or provided code instructions from one or more modules to consolidate the commercial and financial data to provide a credit report for each of the at least one client business. The processor may also be configured, programmed and/or provided code instructions from one or more modules to transmit the report to at least one visibility user terminal 116, such as financial institution terminal with preauthorized access rights, to facilitate the financial institution's credit operations and risk management.

The visibility to financial institutions and companies may be achieved by the presentation of the information in a web-based software or any other kind of online service. This allows financial institutions to consider suppliers and clients in the credit analysis process. As can be appreciated, the visibility system 105 provides added value to financial institutions (to make credit offers to potential clients) and to companies (providing more commercial and financial information to a financial institution for reviewing and assessing the companies' credit worthiness and associated risk).

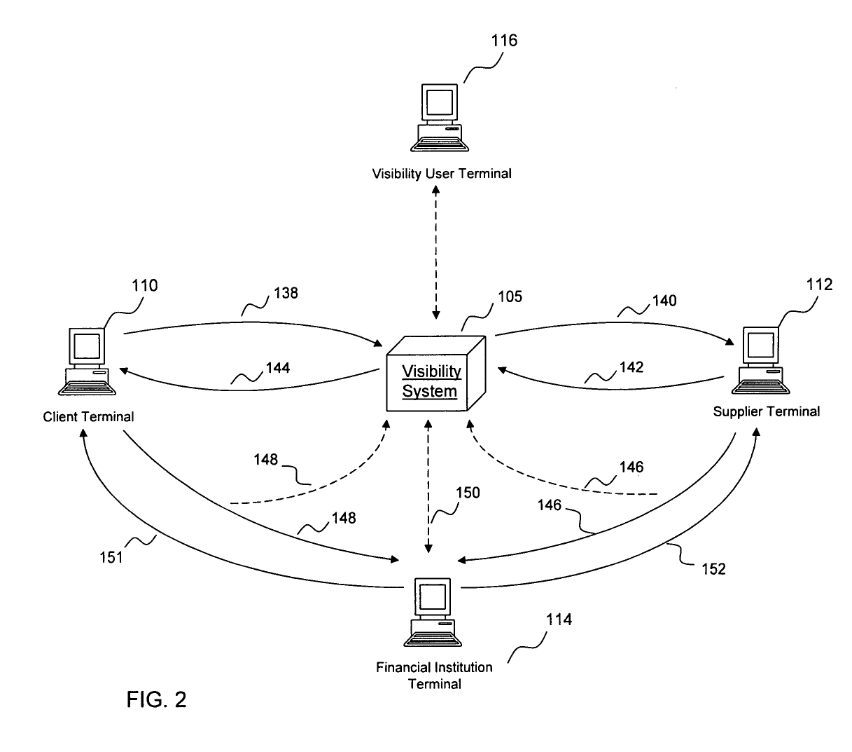

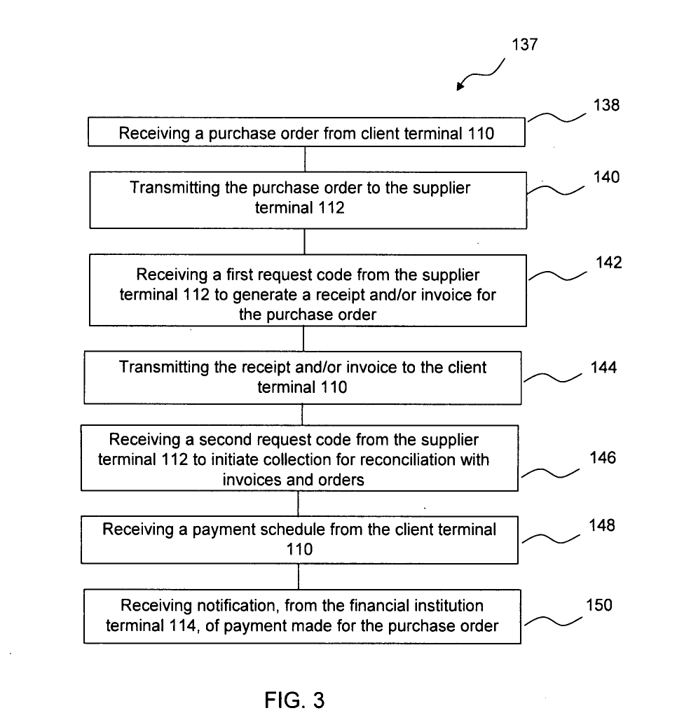

FIG. 2 illustrates an exchange of commercial and financial data through the visibility system 105 of FIG. 1, according to an embodiment of the present disclosure. FIG. 3 illustrates an exemplary flowchart 137 outlining the operation of the visibility system 105 of FIG. 1, according to an embodiment of the present disclosure. As can be appreciated, the server 120 of the visibility system 105 may be programmed with code instructions to facilitate the exchange of commercial and financial data between companies. The visibility system 105 may be programmed, for example, by transmitting code instructions to the server 120 from a local or remote storage device. The server 120 may be programmed with instructions to receive a purchase order from the client terminal 110 (138). The server 120 may store the purchase order information, in the commercial data database 132, as an account payable to the client and account receivable to the supplier. In one embodiment, the stored purchase order information may then be itemized as income/expense and may be accessible for display on the client terminal 110, the supplier terminal 112 and/or the financial institution terminal 114. The stored purchase order information may also be accessible for display to any visibility user 106 with preauthorized rights from the client or supplier.

After receiving the purchase order, the server 120 may transmit the purchase order to the supplier terminal 112 (140). The supplier may then transmit, to the server 120, a first request code to generate a receipt and/or invoice for the purchase order (142). The server 120 may then generate a receipt/invoice and transmit the same to the client terminal 110 (144). In one embodiment, the server 120 may reconcile the information on the receipt with the purchase order. The server 120 may update the account payable to the client and account receivable to the supplier based on the reconciled information. Since the purchase order may be considered a commitment of payment, reconciling the invoice with the supplier's account receivables provides greater level of confidence in the supplier's revenue stream. However, since there is a minor probability that the client cancels the purchase order after the supplier has generated an invoice, the purchase order may be considered a commitment with a greater confidence. This commitment provides visibility, inside the supplier's operations, for a financial institution to guide its credit operations and risk management.

As can be appreciated, the supplier may use the invoice for anticipation of receivables to request a line of credit, from the financial institution, to meet its obligations under the purchase order. Alternatively, the supplier may transmit, to the server 120, a second request code to initiate payment collection, from the financial institution, for reconciliation with the invoice and purchase order, thereby further increasing the confidence level in the records of payables and receivables (146). The client may then transmit a request code to the server 120 to schedule a payment of the invoice with the financial institution (148). The server 120 may store the information as “payables scheduled”, affirming the commitment to the date scheduled. Once the payment is made on the scheduled date, the financial institution terminal 114 may transmit a notification to the client and the supplier, via the server 120 (150). The liquidation of payment closes the cycle of the invoice/receipt/order, and may be identified as “liquidated” on the server 120.

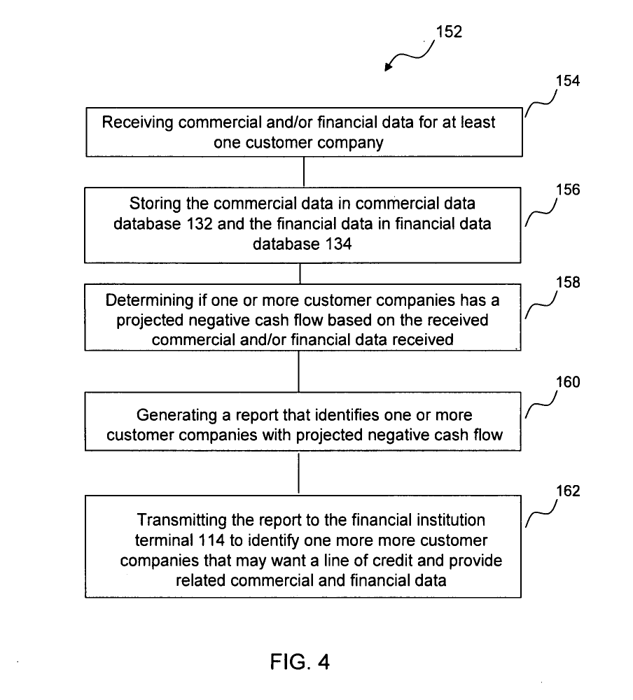

FIG. 4 illustrates an exemplary flowchart 152 outlining the operation of the visibility system 105 of FIG. 1 for identifying, to a financial institution, potential companies qualified to receive credit, according to an embodiment of the present disclosure. Financial institutions generally have certain criteria for extending credit based on their credit operational guidelines and risk management. As can be appreciated, this criteria may be provided to the visibility system 105, via the financial institution terminal 114. Based upon a company's commercial and/or financial activity, the visibility system 105 may determine whether the company satisfies the financial institution's criteria for receiving credit. The visibility system 105 may then identify the pre-qualified company to the financial institution for extending credit. In one embodiment, the visibility system 105 identifies one or more pre-qualified companies to the financial institution periodically, for example, hourly, daily, monthly, quarterly, etc.

The visibility system 105 may generate a Cash Need Report that provides information on one or more companies that have a projected negative cash flow. The Cash Need Report may be used by the financial institution to identify potential clients for credit operations. In one embodiment, the Cash Need Report may be provided to the financial institution in response to an online search criteria transmitted from the financial institution terminal 114 to the visibility system 105. Alternatively, the Cash Need Report may be automatically generated on all participating companies (companies that authorized inclusion on the report) to allow the financial institution to review and identify potential clients for credit operations.

In one embodiment, the visibility system 105 may also generate a Cash Flow Report to provide all financial transactions of a company within a certain period. Based on the company's cash flow information, the financial institution may be able to determine whether the company will be able to pay monthly for a loan or default on the loan. The Cash Flow Report may be provided to the financial institution in response to an online search criteria transmitted from the financial institution terminal 114 to the visibility system 105. Alternatively, the visibility system 105 may also automatically generate the Cash Flow Report on all participating companies to allow the financial institution to review and identify potential clients with sufficient cash flow for extending a line of credit.

As can be appreciated, the server 120 of the visibility system 105 may be programmed with code instructions for identifying, to a financial institution, potential companies qualified to receive credit. The visibility system 105 may be programmed, for example, by transmitting code instructions to the server 120 from a local or remote storage device. Referring to FIG. 4, the server 120 may be programmed with instructions to receive commercial data from at least one customer company via terminals 110 or 112 and/or financial data for each customer company from at least one terminal 114 (154). The commercial data may be stored in commercial data database 132 and the financial data may be stored in financial data database 134 (156). Next, the server 120 may be programmed to determine if one or more customer company has a projected negative cash flow based on the received commercial and/or financial data received (158). The server 120 may generate a report, such as a Cash Need Report, to identify the one or more customer company with projected negative cash flow (160). The server 120 may then transmit the report to the financial institution terminal 114 to identify one or more customer company that may want a line of credit (162). The server 120 may also generate a Cash Flow Report, to provide all financial transactions on one or more customer company within a certain period. As noted above, the reports may be provided to the financial institution in response to an online search criteria transmitted from the financial institution terminal 114 to the visibility system 105. Alternatively, the reports may be automatically generated on all participating customer companies (companies that authorized inclusion on the report) to allow the financial institution to review and identify potential clients that may want or need a line of credit.

As can be appreciated, a customer company may authorize the financial institution to access the company's commercial and financial records. With authorized access to the company's commercial and financial records, the financial institution can better assess the risk associated with extending a credit line to the company. In one embodiment, the financial institution may receive real-time data of the customer company's commercial and financial activity. As such, the financial institution can, for example, determine whether the company, with negative cash flow, has accounts receivables from purchase orders that will cover for the line of credit. Similarly, the financial institution can also determine if a company can make a certain monthly payment on a loan based on the company's cash flow records. If so, the financial institution can extend the line of credit with higher confidence and reduced risk that the company would default on the loan.

By storing commercial and financial records, the visibility system 105 may be configured to analyze the activity of a company, its clients, suppliers and financial agents, and provide statistical data in real time, with greater precision, regarding new service and credit offerings. This statistical data may be used to provide instantaneous business intelligence, helping the decision making and business response time to changes in the market. The real-time map of companies and their value-chain may allow the offering of immediate credit service using transactions and real-time confirmation of the involved companies as collateral to this operation.

Generally, prior art credit operations are based on historic behavior data and associated rating. However, this data is not enough to define the amount of transactions being done by a company or it's financial and productive capacity, or to understand the value-chain companies involved, which company participating in which value-chain, and the financial and mercantile capacities of the value-chain. Credit operations using paper transactions as collateral, without real time mercantile transactions, cannot assure that the company will be able to pay for the loan. As such, prior art credit operations are high risk transactions. Any oscillation in the market can affect many companies, and the systemic risk is not taken into consideration.

Using the visibility system 105 to provide real-time mercantile operations as collateral, and having one or more databases to converge this information, companies may now be better positioned to prove their payment capacity. Furthermore, the systemic risk (the risk of the whole value-chain) can be analyzed in real time. As such, the credit limit that a financial institution can concede to each company can be safely established based on confirmed receivables each company has. This allows the financial institution to offer credit with lower interest rate, and companies receiving this credit with lower interest rate are likely to become more competitive in the marketplace.

In this description, various functions and operations may be described as being performed by or caused by software code to simplify description. However, those skilled in the art will recognize that what is meant by such expressions is that the functions result from execution of the code/instructions by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system. While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time. Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

The computer-readable media may store the instructions. In general, a tangible machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system. Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

The disclosure includes methods and apparatuses which perform these methods, including data processing systems which perform these methods, and computer readable media containing instructions which when executed on data processing systems cause the systems to perform these methods.

While the methods and systems have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

In this regard it should be understood that for practical reasons and so as to avoid adding potentially hundreds of claims, the applicant has presented claims with initial dependencies only.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A system for providing real-time data of commercial and financial activity of a business to a financial institution for visibility to guide credit operations and risk management, the system comprising:
a storage device to store data including commercial information and financial information on a plurality of businesses; and
a processor configured to:
retrieve the data from the storage device,
generate a report to identify at least one business that has a projected negative cash flow;
transmit the report to at least one financial institution terminal to facilitate a financial institution's credit operations and risk management.

2. The system of claim 1, wherein the report is a cash need report accessible to a financial institution to identify at least one business to extend credit.

3. The system of claim 1, wherein the processor is further configured to determine if at least one business has a projected negative cash flow, prior to generating the report.

4. The system of claim 1, wherein the processor is further configured to generate a cash flow report to allow the financial institution to evaluate the financial condition of the at least one business within a certain period.

5. The system of claim 1, wherein the report is generated and transmitted periodically to the at least one financial institution terminal.

6. The system of claim 1, wherein the commercial information is selected from a group consisting of purchase orders, receipts, invoices, titles, and contracts.

7. The system of claim 1, wherein the financial information is selected from a group consisting of payments, collections, bank statements and credit card statements.

8. A system for providing real-time data of commercial and financial activity of a business to a financial institution, the system comprising:
a first storage device to store data including commercial information and financial information on a plurality of businesses in a value chain; and
at least one processor to execute code instructions to perform real-time integration of the commercial information received from a plurality of business terminals, the at least one processor further executes code instructions to extract financial information from the commercial information and determine if at least one business has a projected negative cash flow.

9. The system of claim 8, wherein the at least one processor further executes code instructions to generate a cash need report to identify at least one business that has a projected negative cash flow.

10. The system of claim 8, wherein the at least one processor further executes code instructions to transmit the report to at least one financial institution terminal to facilitate a financial institution's credit operations and risk management.

11. The system of claim 8, wherein the at least one processor further executes code instructions to facilitate commercial and financial transactions.

12. The system of claim 8, wherein the at least one processor further executes code instructions to generate a cash flow report, the at least one processor further executes code instructions to transmit the cash flow report to at least one financial institution terminal to evaluate the financial condition of the at least one business within a certain period.

13. The system of claim 8, wherein the commercial information is selected from a group consisting of purchase orders, receipts, invoices, titles, and contracts.

14. The system of claim 8, wherein the financial information is selected from a group consisting of payments, collections, bank statements and credit card statements.

15. The system of claim 8, further comprising:
a second storage device to store data associated with a customer account to access the system;
wherein the at least one processor being responsive to the receipt of the data associated with the customer account upon log in to the system, the at least one processor further executes code instructions to verify the user's membership to access the system.

16. A method for providing real-time data of commercial and financial activity of a business to a financial institution for visibility to guide credit operations and risk management, the method comprising:
receiving real-time commercial data from a plurality of business terminals and real-time financial data, for each business, from a plurality of financial institution terminals;
storing the real-time commercial data and the real-time financial data in a storage device;
transmitting code instructions to a processor to determine, from the real-time commercial data and the real-time financial data, if at least one business has a projected negative cash flow; and
transmitting code instructions to a processor to generate a report to identify the at least one business that has the projected negative cash flow.

17. The method of claim 16, further comprising transmitting the report to at least one financial institution terminal to facilitate a financial institution's credit operations and risk management.

18. The method of claim 16, further comprising:
transmitting code instructions to a processor to generate a cash flow report of the at least one business within a certain period; and
transmitting the cash flow report to at least one financial institution terminal to evaluate the monthly payment capacity of the at least one business.

19. A computer readable medium having stored thereon a set of instructions, which when executed by a computer having a processor and a memory, cause the computer to perform operations, comprising:
receiving real-time commercial and financial data;
storing the real-time commercial and financial data in a storage device;
determining, from the real-time commercial and financial data, if at least one business has a projected negative cash flow;
generating a report to identify the at least one business that has the projected negative cash flow; and
transmitting the report to at least one financial institution terminal to facilitate a financial institution's credit operations and risk management.

20. The computer readable medium of claim 19, further comprising:
generating a cash flow report of the at least one business within a certain period; and
transmitting the cash flow report to at least one financial institution terminal to evaluate the monthly payment capacity of the at least one business.
